(19) United States
(12) Patent Application Publication
(10) Pub. No.: US 2026/0329941 A1
(43) Pub. Date: Oct. 22, 2026

(54) QUERYING DATA

(71) Applicant: Dell Products L.P., Round Rock, TX (US)

(72) Inventors: Xiao Le Shang, Shanghai (CN); Xia Wang, Shanghai (CN); Iris Yun Yang, Shanghai (CN); Young Yangchun Wu, Changsha (CN); Flora Xiaoling Fu, Shanghai (CN); Yang Xu, Shanghai (CN)

(21) Appl. No.: 19/243,611

(22) Filed: Jun. 19, 2025

(30) Foreign Application Priority Data
Apr. 18, 2025 (CN) 202510495527.4

(51) Int. Cl. G06F 16/903; G06F 16/907

(52) U.S. Cl. CPC G06F 16/90335; G06F 16/907

(57) ABSTRACT

The present disclosure relates to querying data. An example method includes, in response to receiving a request for data query from a client, determining a metadata list of an object that meets the request. The method includes creating a virtual object based on the metadata list, the virtual object including an identifier and a data index. The method further includes determining response data for the request based on the virtual object. In addition, the method further includes sending the response data to the client. In this way, by using this solution, a large number of objects can be acquired in one query, which reduces the consumption of computing resources, reduces the query time, and improves the efficiency of data query.

### RELATED APPLICATION

The present application claims the benefit of priority to Chinese Patent Application No. 202510495527.4, filed on Apr. 18, 2025, which application is hereby incorporated into the present application by reference herein in its entirety.

### TECHNICAL FIELD

The present invention relates to the field of computers, and, for example, to a method, device, and computer program product for querying data.

### BACKGROUND

An object storage system is storage architecture that stores and manages data as objects. An object consists of data, metadata (which describes properties of the object), and a unique identifier. The object storage system is different from a conventional file system (which stores data in a file directory hierarchy) and block storage (which is directly connected to a storage device). Basic components of the system include an object, a storage bucket, and an object storage server. The storage bucket is similar to a folder and is used for storing the object, and can set an access control policy. The object storage server is responsible for storing data and metadata, usually uses distributed architecture, and can process a large number of concurrent read and write requests. Objects may be stored on different physical storage devices according to storage policies (such as data redundancy policies), so as to improve the data reliability and availability. For example, some object storage systems replicate data of objects to a plurality of servers to prevent data loss due to a single server failure.

### SUMMARY

A method, device, and computer program product for querying data are provided in embodiments of the present invention.

According to a first aspect of the embodiments of the present invention, a method for querying data is provided. The method includes in response to receiving a request for data query from a client, determining a metadata list of an object that meets the request. The method includes creating a virtual object based on the metadata list, the virtual object including an identifier and a data index. The method further includes determining response data for the request based on the virtual object. In addition, the method further includes sending the response data to the client.

According to a second aspect of the embodiments of the present invention, an electronic device is provided, including:
at least one processor; and coupled to the at least one processor and having instructions stored thereon, where the instructions, when executed by the at least one processor, cause the electronic device to perform actions including in response to receiving a request for data query from a client, determining a metadata list of an object that meets the request. The actions include creating a virtual object based on the metadata list, the virtual object including an identifier and a data index. The actions further include determining response data for the request based on the virtual object. In addition, the actions further include sending the response data to the client.

According to a third aspect of the embodiments of the present invention, a computer program product is provided, which is tangibly stored on a non-volatile computer-readable medium and includes machine-executable instructions, where the machine-executable instructions, when executed, cause a machine to perform actions including in response to receiving a request for data query from a client, determining a metadata list of an object that meets the request. The actions include creating a virtual object based on the metadata list, the virtual object including an identifier and a data index. The actions further include determining response data for the request based on the virtual object. In addition, the actions further include sending the response data to the client.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals always represent identical or similar elements, and in the accompanying drawings:

FIG. 1 illustrates a schematic diagram of an example of an object storage system providing an object query service;

FIG. 2 illustrates a schematic diagram of an overall environment for implementing an embodiment of the present disclosure;

FIG. 3 illustrates a flow chart of a method for querying data according to some embodiments of the present disclosure;

FIG. 4 illustrates a schematic diagram of an example of a request for data query according to some embodiments of the present disclosure;

FIG. 5 illustrates a schematic diagram of an example of response data according to some embodiments of the present disclosure;

FIG. 6 illustrates a schematic diagram of an example of a virtual object and reading a matched object by utilizing the virtual object according to some embodiments of the present disclosure;

FIG. 7 illustrates a schematic diagram of an example of an overall process for querying data according to some embodiments of the present disclosure; and

FIG. 8 illustrates a schematic block diagram of an example device suitable for implementing an embodiment of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of the embodiments of the present disclosure, the term "include," "have,” and similar terms thereof should be understood as open-ended inclusion, that is, "including but not limited to.” The term "based on" should be understood as "based at least in part on.” The term "embodiment," "one embodiment," or "this embodiment" should be understood as "at least one embodiment.”

As used herein, unless explicitly stated otherwise, the term "or" covers all possible combinations, unless not feasible. For example, if it is stated that a component may include A or B, unless otherwise explicitly stated or not feasible, the component may include A, or B, or A and B. As a second example, if it is stated that a component may include A, B, or C, unless otherwise explicitly stated or not feasible, the component may include A, or B, or C, or A and B, or A and C, or B and C, or A and B and C.

Although object storage systems have significant advantages, such as high scalability, high data persistence, security, and low cost, for objects with small data volumes (also referred to as "small objects" or "small files," with data volumes usually less than 100 KB), the access performance is low and the objects can only be retrieved one by one according to object names. In application scenarios where a large number of small files need to be accessed (or queried), the consumption of computing resources is large, the access time is long, and accordingly, the access efficiency is also low. Small objects are critical to supporting AI/ML/DL workloads, deduplication archive/backup, monitoring and logging data, IoT applications, analytical databases, and the like, and therefore, improvements to object storage systems are expected.

Therefore, the present disclosure provides a solution for querying data. In an embodiment of the present disclosure, based on a query request received from a client, a metadata list of an object that meets the query request is obtained from metadata, and a virtual object is created by utilizing the metadata list. An identifier and a data index in the virtual object can be used to acquire response data for the query request. By using this solution, a large number of objects can be obtained in one query, which reduces the consumption of computing resources, reduces the query time, and improves the efficiency of data query.

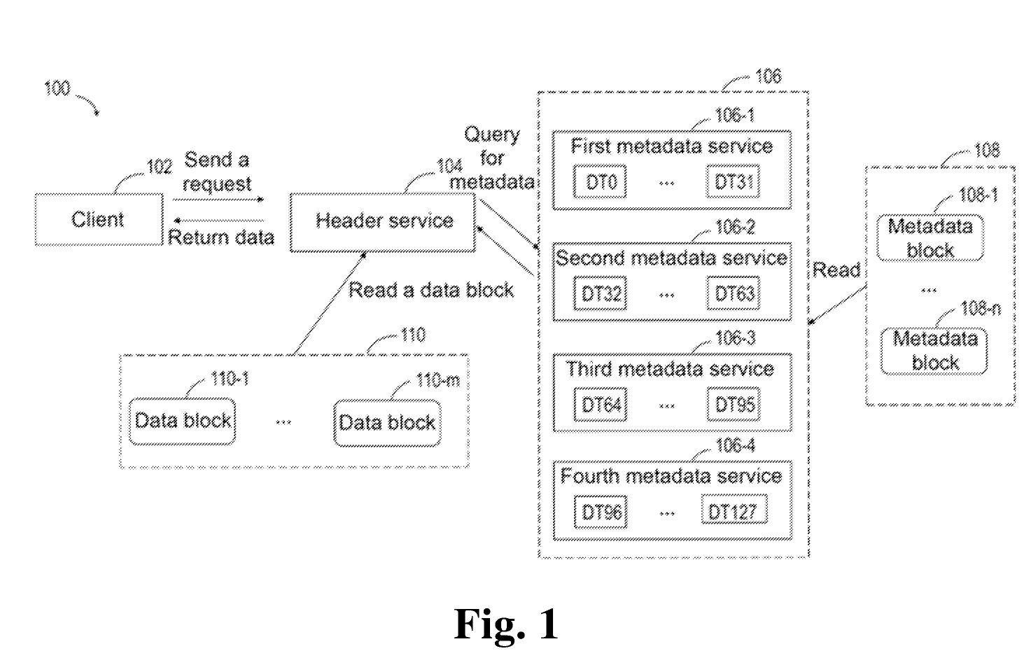

The following describes the process and corresponding disadvantages of an object storage system when querying small objects with reference to FIG. 1. FIG. 1 illustrates a schematic diagram of an example 100 of an object storage system providing an object query service. As shown in FIG. 1, a client 102 sends a request for querying an object to a header service 104 (a processing module in the object storage system) in the object storage system. For example, when 10,000 10KB-objects need to be queried, a request for one of the objects is sent at a time. After receiving a query request for an object, the header service 104 triggers a metadata service 106 (which is also a processing module in the object storage system) to query metadata of the object.

The metadata service 106 in the example object storage system includes four metadata service groups, namely, a first metadata service 106-1, a second metadata service 106-2, a third metadata service 106-3, and a fourth metadata service 106-4. The example object storage system includes 128 metadata parallel processing engines (also referred to herein as directory tables, DT for short), which are equally distributed in number in the metadata service groups. For example, DT0 to DT31 are distributed in the first metadata service 106-1, DT32 to DT63 are distributed in the second metadata service 106-2, DT64 to DT95 are distributed in the third metadata service 106-3, and DT96 to DT127 are distributed in the fourth metadata service 106-3.

In the example 100, the metadata service 106 reads metadata for the object from a metadata block 108 (including a metadata block 108-1, ..., and a data block 108-n). After completing the metadata query for the object, the metadata of the object is returned to the header service 104. The header service 104 obtains a data index of the object by parsing the metadata of the object, then reads data of the object in a data block 110 (including a data block 110-1, ..., and a data block 110-m) according to the data index, and returns the data to the client 102. For the case of querying 10,000 10KB-objects, the above query method is repeated 10,000 times to complete the query. In the above query method, the processing time for metadata in a single query accounts for a high proportion of the single query time, and the round-trip time of a single query is also not negligible, so the total query round-trip time is also high. Therefore, the object query performed by the above object storage system consumes a significant number of computing resources, has a long query time, and is inefficient.

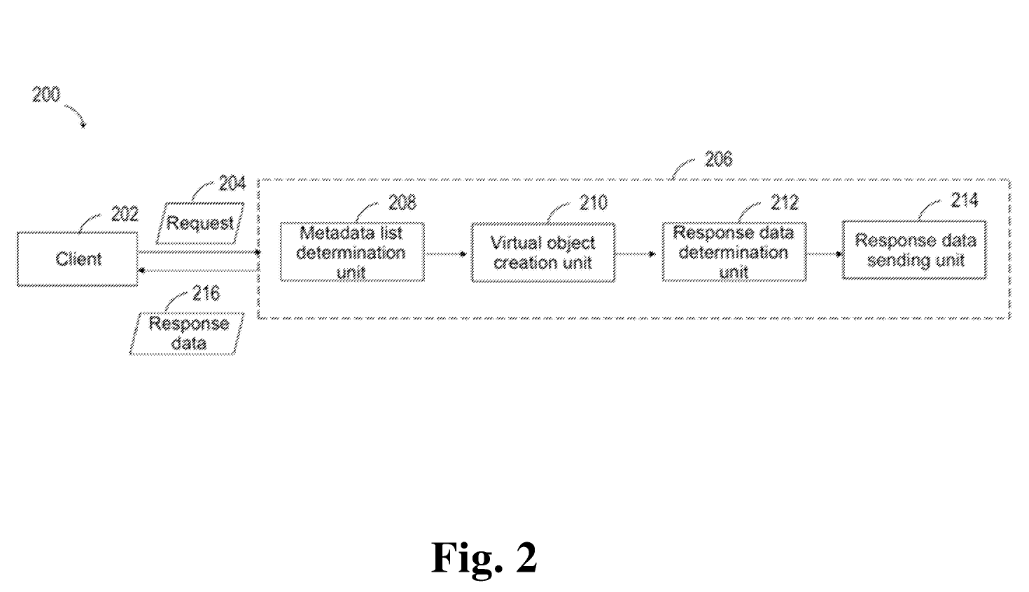

FIG. 2 illustrates a schematic diagram of an overall environment 200 for implementing some embodiments of the present disclosure. As shown in FIG. 2, the environment 200 includes a client 202 and a computing device 206. The computing device 206 includes a metadata list determination unit 208, a virtual object creation unit 210, a response data determination unit 212, and a response data sending unit 214. In some embodiments, the computing device 102 may include, but is not limited to, a personal computer, a server computer, a handheld or laptop device, a mobile device (such as a mobile phone, a personal digital assistant (PDA), and a media player), a multiprocessor system, a consumer electronic product, a wearable electronic device, a smart home device, a minicomputer, a mainframe computer, an edge computing device, a distributed computing environment including any of the above systems or devices, and the like.

In the environment 200, the client 202 sends a request 204 for querying data to the computing device 206. After the computing device 206 receives the request 204, the metadata list determination unit 208 reads metadata of a plurality of objects that meet the request from a metadata block based on information included in the request 204, such as the type of object, and combines the metadata into a metadata list and provides the metadata list to the virtual object creation unit 210.

In the environment 200, the virtual object creation unit 210 obtains metadata for creating a virtual object from the metadata list provided thereto, and the metadata constitutes a data index in the virtual object. A virtual object is similar to a real object and also includes an identifier to uniquely identify the virtual object. After the creation of the virtual object is completed, the virtual object creation unit 210 provides the virtual object to the response data determination unit 212.

In the environment 200, the response data determination unit 212 reads, from a data block, data of the object that meets the request 204 by utilizing the virtual object provided thereto, and obtains, by utilizing the virtual object and the read data, response data to be sent to the client 202. In some embodiments, the response data not only includes the read data, but also includes other data (for example, some information related to the read data). The response data determination unit 212 provides the response data to the response data sending unit 214, and the response data sending unit 214 sends the response data to the client 202.

In this way, by using the virtual object created by the virtual object creation unit 210, a plurality of objects that meet the request 204 from the client 202 can be acquired in a single query, thereby reducing the number of query round trips for the request 204. Moreover, a plurality of objects can be processed in a single query, it is equivalent to that the amount of data processed in a single query is increased, and therefore, the number of processes per unit time is reduced, thereby reducing the consumption of computing resources, reducing the access time, and improving the efficiency of data query.

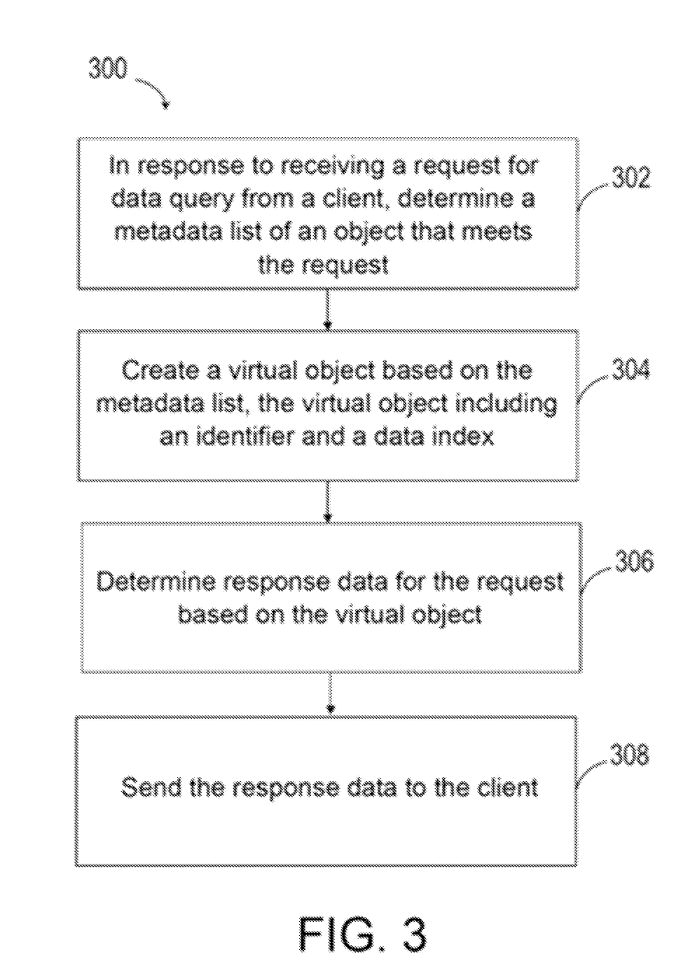

FIG. 3 illustrates a flow chart of a method 300 for querying data according to some embodiments of the present disclosure. The method 300 may be performed by the computing device 206 in the environment 200 in FIG. 2. Furthermore, the numbering in the flow chart does not indicate the order in which these steps are executed, and some of or all these steps may be executed in parallel, or the execution order can be reversed, which is not limited in the present disclosure.

At block 302, the method 300 includes, in response to receiving a request for data query from a client, determining a metadata list of an object that meets the request. In some embodiments, as shown in FIG. 2, the metadata list determination unit 208 receives a request 204 for data query from the client 202, and obtains a metadata list of the object that meets the request 204 from a metadata block by utilizing the request 204. In some embodiments, the request 204 may be a data request input by a user to a client according to own data needs of the user. For example, the request 204 may be querying for pictures containing animals, querying for videos during a certain time period, querying for text on a certain topic, querying for audio of a specific tone, and the like.

At block 304, the method 300 includes creating a virtual object based on the metadata list, the virtual object including an identifier and a data index. In some embodiments, as shown in FIG. 2, the virtual object creation unit 210 acquires, from the metadata list provided thereto, metadata for creating a virtual object, such as a name of the object, a position of the object in a data block, and the size of the object. These pieces of metadata constitute the data index in the virtual object. In addition, the virtual object creation unit 210 further generates, for the virtual object, an identifier used for uniquely representing the virtual object, such as a combination of a string of numbers and letters. In some embodiments, the identifier of the virtual object is provided by the user to the computing device 206 when data transmission is interrupted, and the computing device 206 finds the virtual object corresponding to the identifier based on the identifier.

At block 306, the method 300 includes determining response data for the request based on the virtual object. In some embodiments, as shown in FIG. 2, the response data determination unit 210 reads, from the data block, data of the object that meets the request 204 by utilizing the data index in the virtual object provided thereto, and combines the data with other data into response data. For example, the other data may function to assist the client 202 in splitting the data in the response data.

At block 308, the method 300 includes sending the response data to the client. In some embodiments, as shown in FIG. 2, the response data sending unit 214 sends the response data provided thereto to the client 202, so as to complete the response to the request 204. In some embodiments, when there are many objects that meet the request 204, the response data sending unit 214 may also send response data to the client 202 in batches. For example, if there are 100,000 objects that meet the request 204, the response data sending unit 214 may send response data of 20,000 objects that meet the request 204 to the client 202 in each batch.

By the method 300 described with reference to FIG. 3, the consumption of computing resources is reduced, the query time is reduced, and the efficiency of data query is improved.

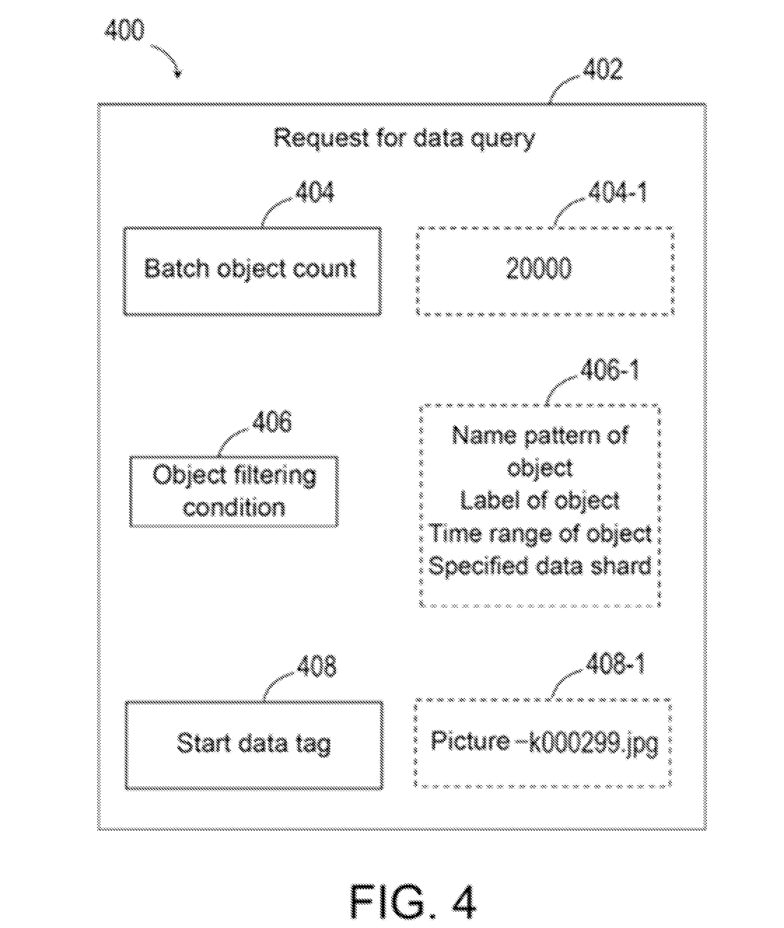

FIG. 4 illustrates a schematic diagram of an example 400 of a request for data query according to some embodiments of the present disclosure. In the example 400, a request 402 for data query may include a batch object count 404, an object filtering condition 406, and a start data tag 408. In some embodiments, the batch object count 404 is used for limiting the number of objects corresponding to data returned at a single time, and is usually set by the user of the client, or set in a relevant protocol of the client. An example of the batch object count 404 may be a batch object count 404-1, which has a value of 20,000.

In some embodiments, the object filtering condition (also referred to as an “object matching condition”) 406 is used for filtering out objects required by the user, and is usually input into the client by the user according to data requirements of the user. An example of the object filtering condition 406 may be an object filtering condition 406-1, which includes a name pattern of object, a label of object, a time range of object, and a specified data shard. The object filtering condition 406 may also be any condition or a combination of a plurality of conditions in the object filtering condition 406-1. In some embodiments, the name pattern of object may be, for example, a name pattern that supports a regular expression. For example, a name of a picture object is picture-xy*.jpg. The label of object may be, for example, a label defined by the user for the object. Taking a picture as an example, the label defined by the user for a picture may be diverse, for example, a content description label (such as subject description, subject behavior description, and color tone description), a time and place label (such as "xx/xx/xx," "xx Park," and "xx Street"), a usage classification label (such as "animal," "plant," "for training," and "for machine learning"), and a data set label (such as "training data set" and "validation data set"). The time range of object may be, for example, from xx/xx/xx to yy/yy/yy, the past n days, and the like. The specified data shard can limit which logical partition (or logical shard) the data to be returned comes from, for example, designating one or more of: a hash algorithm for the shards of the data to be returned, a sharding factor (for example, for the object storage system shown in FIG. 1, the sharding factor is 128), and the number of logical partitions.

In some embodiments, the start data tag 408 is used for indicating a position for starting reading in the metadata block or in the data block. The start data tag 408 may be specified, and an example of the specified start data tag 408 may be a start data tag 408-1. The start data tag 408-1 is picture-k000299.jpg, indicating that metadata or data is to be read starting from a position, in a metadata block or in a data block, corresponding to an object marked as picture-k000299.jpg. The start data tag 408 may not be specified. The unspecified start data tag 408 indicates that metadata or data is to be read from a start position of a metadata block or a data block.

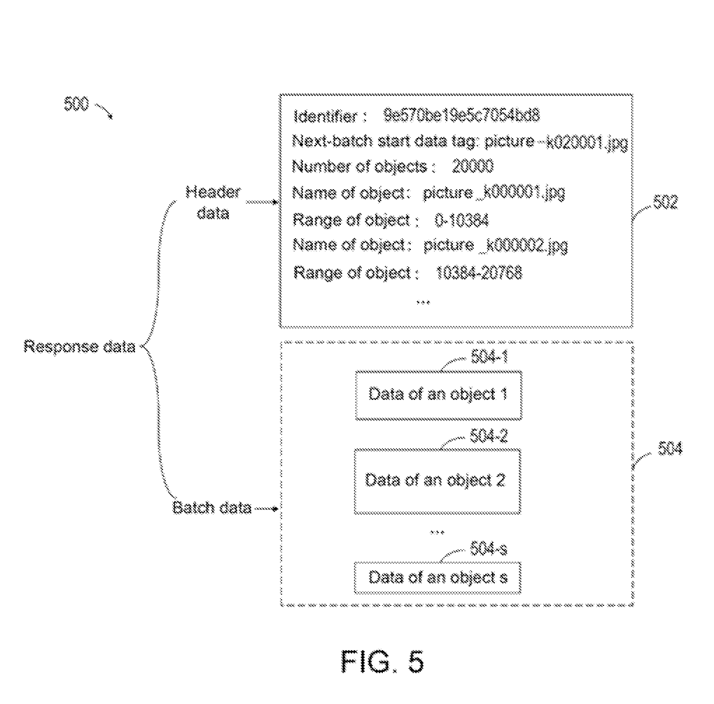

FIG. 5 illustrates a schematic diagram of an example 500 of response data according to some embodiments of the present disclosure. In the example 500, the response data includes header data and batch data. In some embodiments, the header data includes an identifier, the number of objects, a next-batch start data tag, a name of the object, and a range of the object data in the response data. A value of the identifier is the identifier of the virtual object, for example, 9e570be19e5c7054bd8. A value of the number of objects is the object batch count described in the example 400, for example, 20,000. The next-batch start data tag is determined by the value of the number of objects and a data tag of the first object of the current batch data. For example, if the value of the number of objects is 20000 and the data tag of the first object of the current batch data is picture-k000001.jpg, the next-batch start data tag is picture-k020001.jpg. The name of the object may be, for example, picture_k000001.jpg, picture_k000002.jpg, or the like. The range of the object data in the response data is that, for example, a range of an object 1 is 0-10384B, a range of an object 2 is 10384-20768B, and so on.

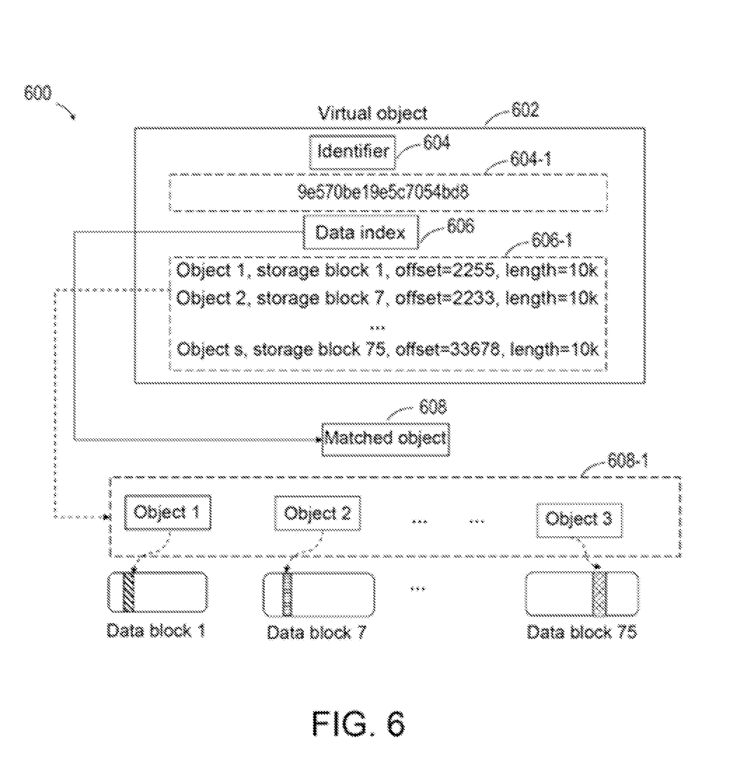

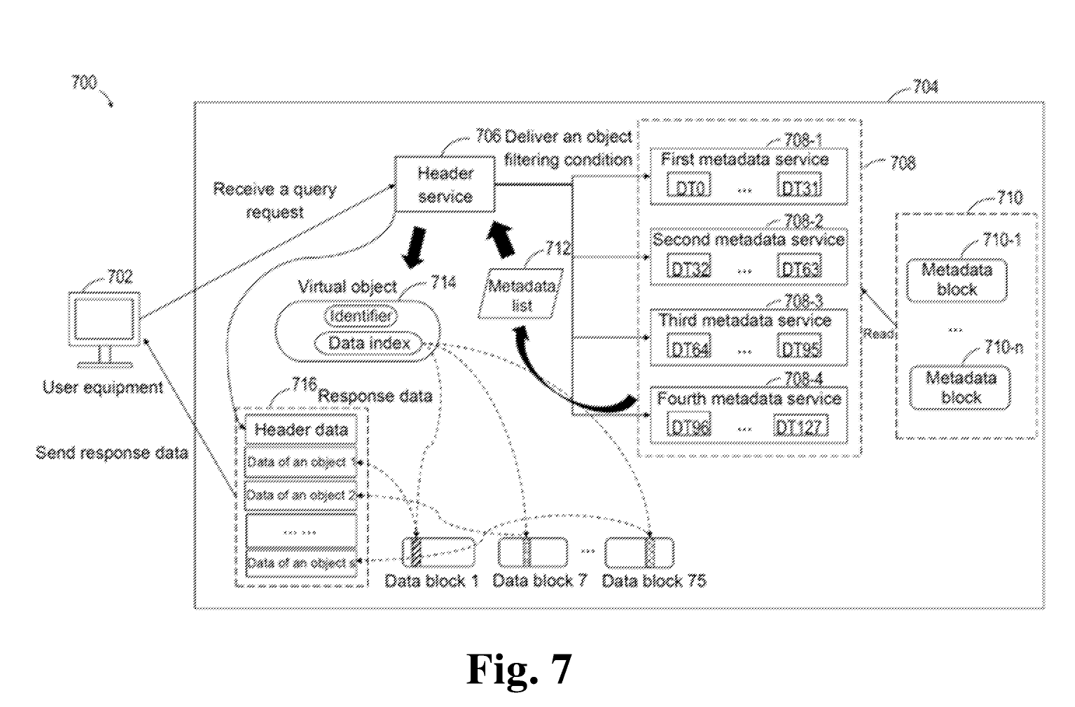

In some embodiments, the batch data is data transmitted in a single return for a client request, and is composed of data 504 of objects that meet the object filtering condition, where the data 504 includes data 504-1 of the object 1, data 504-2 of the object 2, ..., and data 504-s of an object s. The specific details on how to obtain the header data and batch data and then obtain the response data sent to the client will be explained below with reference to the description of FIGS. 6 and 7.

FIG. 6 illustrates a schematic diagram of an example 600 of a virtual object and reading a matched object by utilizing the virtual object according to some embodiments of the present disclosure. In the example 600, a virtual object 602 includes an identifier 604 and a data index 606. The identifier 604 may be a combination of letters and numbers, an example of which may be an identifier 604-1, and a corresponding value thereof is 9e570be19e5c7054bd8. The data index 606 is used for reading data of an object that meets an object filtering condition in a data block, thereby obtaining the data of a matched object 608. An example of the matched object 608 is an object 608-1, which includes an object 1, an object 2, ..., and an object s.

An example of the data index 606 may be a data index 606-1. The data index 606-1 includes an object name, for example, the object 1, the object 2, ..., and the object s, a data block where the data of the object is located, for example, a data block 1 where the data of the object 1 is located, a data block 7 where the data of the object 2 is located, ..., and a data block 75 where the data of the object s is located, an offset of the data of the object in the data block, for example, an offset of the data of the object 1 in the data block is 2255, an offset of the data of the object 2 in the data block is 2233, ..., and an offset of the data of the object s in the data block is 33678, and a data length of the object, for example, a data length of the object 1 is 10k, a data length of the object 2 is 10k, ..., and a data length of the object s is 10k.

FIG. 7 illustrates a schematic diagram of an example 700 of an overall process for querying data according to some embodiments of the present disclosure. In the example 700, user equipment 702 sends a request for querying data to a server 704. The server 704 is a storage system capable of storing data in a data block and storing metadata in a metadata block, and includes a header service 706 and a metadata service 708. The header service 706 and the metadata service 708 may be, for example, programs, processing modules, and the like. The metadata service 708 includes four metadata service groups, namely, a first metadata service 708-1, a second metadata service 708-2, a third metadata service 708-3, and a fourth metadata service 106-4, and metadata parallel processing engines DT0 to DT127 are evenly distributed in number in the metadata service groups. After the request for querying data is received, it is processed by the header service 706 and the metadata service 708, and response data 716 that meets the object filtering condition in the request is obtained and sent to the user equipment 702.

In the example 700, after receiving the request for querying data, the header service 706 provides the request to the metadata service 708, and the object filtering condition in the request is distributed to each metadata service group in the metadata service 708. The metadata parallel processing engine in each metadata service group reads metadata of objects that meet the object filtering condition in parallel from a metadata block 710 (which includes a metadata block 710-1, ..., and a metadata block 710-n) according to the object filtering condition. If the start data tag in the request is specified, the metadata is read in the metadata block starting from a position corresponding to an object of the start data tag (if not specified, starting from a start position of each metadata block) and according to a reading manner in which a sequence number value in a data tag is not less than a sequence number value in the start data tag. Then, the metadata service 708 combines the read metadata into a metadata list 712 and returns it to the header service 706.

In the example 700, after obtaining the metadata list 712, the header service 706 generates an identifier used for uniquely representing the virtual object, selects, from the metadata list 712, metadata for reading data of objects that meet the object filtering condition in the data block as a data index, and creates a virtual object 714 by utilizing the generated identifier and data index. In some embodiments, the header service 706 sets an expiration time for the header service 706 so that the virtual object is automatically deleted when it expires, so as to reduce the consumption of storage resources in the server.

In the example 700, the header service 706 reads data of objects that meet the object filtering condition in the data block according to the data index in the virtual object 714 and the start data tag in the request. For example, data of the object 1 is read in the data block 1 according to the data index of the object 1, data of the object 2 is read in the data block 7 according to the data index of the object 2, ..., and data of the object s is read in the data block 75 according to the data index of the object s.

In addition, the header service 706 further creates header data based on the virtual object 714 and the request, including setting the batch object count in the request to the number of objects in the header data, setting the identifier of the virtual object 714 to an identifier in the header data, and determining a next-batch start data tag in the header data according to the value of the number of objects and a data tag of the first object of the current batch data. The created header data includes the identifier, the number of objects, the next-batch start data tag, the name of the object, and the range of the object data in the response data.

In the example 700, the header service 706 obtains the response data 716 by utilizing the header data and the batch data, and sends it to the user equipment 702. In some embodiments, when the number of objects that meet the object filtering condition is large, the server 704 usually sends response data in batches. When the network connection between the user equipment 702 and the server 704 is good, the total number of objects corresponding to the current batch of response data sent to the user equipment 702 is the object limit count, and the next-batch start data tag is used for instructing the header service 706 to start reading from a data position of an object corresponding to the next-batch start data tag in the data block when the next batch of response data is sent, and no longer read the data of an object whose sequence number value in the data tag is less than the sequence number value in the start tag.

In a case where the network connection between the user equipment 702 and the server 704 is interrupted, the header service cannot send response data to the user equipment 702, but may save the virtual object 714 for a period of time. If the user of the user equipment 702 needs to continue receiving data, it is only necessary to input the identifier of the header data and the start data tag in the interrupted response data to the user equipment 702, and the user equipment sends to the server 704 a request to continue loading data, the request containing the identifier of the header data and the start data tag. The server 704 can then find the corresponding virtual object according to the identifier and continue to send response data by utilizing the data index in the virtual object. In this case, the next-batch start data tag is no longer used as the reading start point. Instead, a start data identifier included in the request to continue loading data is used as the reading start point. Batch data whose total number of objects does not exceed the batch object count is read from the data block according to a reading manner in which a sequence number value in a data tag is not less than a sequence number value in the start data tag.

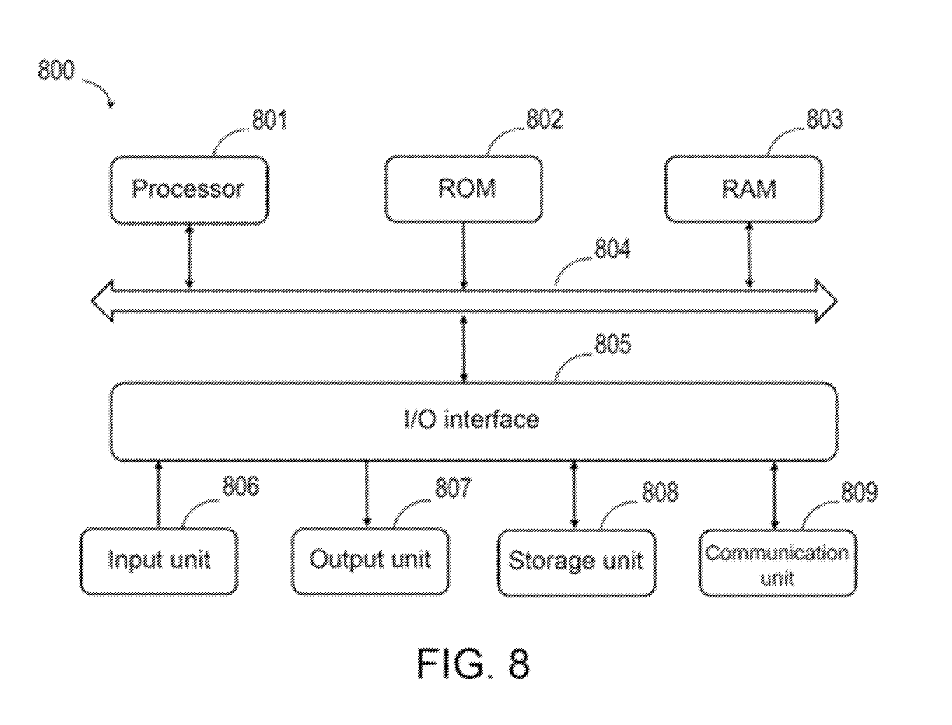

FIG. 8 illustrates a schematic block diagram of an example device 800 that can be used to implement the embodiments of the present disclosure. As shown in the figure, the device 800 includes a processor 801 that can perform various appropriate actions and processing according to computer program instructions stored in a read-only memory (ROM) 802 or computer program instructions loaded from a storage unit 808 to a random access memory (RAM) 803. Various programs and data required for the operation of the device 800 may also be stored in the RAM 803. The processor 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disk; and a communication unit 809, such as a network card, a modem, and a wireless communication transceiver. The communication unit 809 allows the device 800 to exchange information/data with other devices via a computer network, such as the Internet, and/or various telecommunication networks.

The processor 801 may be various general-purpose and/or special-purpose processing components with processing and computing capabilities. Some examples of the processor 801 include, but are not limited to, a central processing unit (CPU), a graphics processing unit (GPU), various specialized artificial intelligence (AI) computing chips, various processors for running machine learning model algorithms, a digital signal processor (DSP), and any appropriate processor, controller, microcontroller, and the like. The processor 801 performs the various methods and processing described above, such as the method 300. For example, in some embodiments, the method 300 may be implemented as a computer software program that is tangibly included in a machine-readable medium such as the storage unit 808. In some embodiments, part or all of the computer program may be loaded and/or installed onto the device 800 via the ROM 802 and/or the communication unit 809. When the computer program is loaded onto the RAM 803 and executed by the processor 801, one or more steps of the method 300 described above can be performed. Alternatively, in other embodiments, the processor 801 may be configured to perform the method 300 by any other suitable manners (e.g., by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method, comprising:
in response to receiving a request for data query from a client, determining a metadata list of an object that satisfies the request;
creating a virtual object based on the metadata list, the virtual object comprising an identifier and a data index;
determining response data for the request based on the virtual object; and
sending the response data to the client.

2. The method according to claim 1, wherein the creating of the virtual object based on the metadata list comprises:
generating an identifier for the virtual object;
acquiring, from the metadata list, metadata for reading data of the object in a data block as the data index; and
creating the virtual object based on the identifier and the data index.

3. The method according to claim 2, wherein the request comprises a start data tag and a batch object count, the response data comprises batch data and header data, and the determining response data for the request based on the virtual object comprises:
reading, according to a reading manner in which a sequence number value in a data tag is not less than a sequence number value in the start data tag, batch data having a total number of objects that does not exceed the batch object count from the data block based on the data index;
creating the header data for the batch data; and
determining the response data for the request based on the batch data and the header data.

4. The method according to claim 3, wherein the creating of the header data for the batch data comprises:
determining the batch object count as the number of objects in the header data;
determining the identifier as an identifier in the header data;
determining a next-batch start data tag in the header data; and
creating the header data for the batch data based on the identifier, the number of objects, the next-batch start data tag, a name of the object, and a range of data of the object in the response data.

5. The method according to claim 4, wherein the sending of the response data to the client further comprises:
in response to interruption of a network connection to the client, saving the virtual object for a period of time; and
in response to receiving from the client a request to continue loading data, sending the response data to the client.

6. The method according to claim 5, wherein the request to continue loading data comprises an identifier for the virtual object and a start data tag, and the sending the response data to the client comprises:
determining the virtual object based on the identifier for the virtual object;
determining response data for the request based on the virtual object and the start data tag; and
sending the response data to the client.

7. The method according to claim 6, wherein the determining of the response data for the request based on the virtual object and the start data tag comprises:
reading, according to a reading manner in which a sequence number value in a data tag is not less than a sequence number value in the start data tag, batch data having a total number of objects that does not exceed the batch object count from the data block based on the data index in the virtual object.

8. The method according to claim 1, wherein the request comprises a start data tag and an object filtering condition, and the determining the metadata list of an object that satisfies the request comprises:
determining, based on the start data tag, a reading manner for metadata in a metadata block;
reading, based on the reading manner, metadata of the object that satisfies the object filtering condition; and
determining the metadata list based on the metadata, wherein the metadata list comprises the metadata.

9. The method according to claim 8, wherein the determining, based on the start data tag, the reading manner for the metadata in the metadata block comprises:
in response to the start data tag being specified, reading the metadata in the metadata block according to a reading manner in which a sequence number value in a data tag is not less than a sequence number value in the start data tag; or
in response to the start data tag not being specified, reading the metadata from a start position in the metadata block.

10. The method according to claim 8, wherein the object filtering condition comprises at least one of:
a name pattern of the object;
a label of the object;
a time range of the object; or
a specified data shard.

11. A device, comprising:
at least one processor; and
a memory coupled to the at least one processor and having instructions stored thereon, wherein the instructions, when executed by the at least one processor, cause the device to perform operations, comprising:
in response to receiving a request for data query from a client, determining a metadata list of an object that meets the request;
creating a virtual object based on the metadata list, the virtual object comprising an identifier and a data index;
determining response data for the request based on the virtual object; and
sending the response data to the client.

12. The device according to claim 11, wherein the creating of the virtual object based on the metadata list comprises r:
generating an identifier for the virtual object;
acquiring, from the metadata list, metadata for reading data of the object in a data block as a data index; and
creating the virtual object based on the identifier and the data index.

13. The device according to claim 12, wherein the request comprises a start data tag and a batch object count, the response data comprises batch data and header data, and the determining of the response data for the request based on the virtual object comprises:
reading, according to a reading manner in which a sequence number value in a data tag is not less than a sequence number value in the start data tag, batch data whose total number of objects does not exceed the batch object count from the data block based on the data index;
creating header data for the batch data; and
determining the response data for the request based on the batch data and the header data.

14. The device according to claim 13, wherein the creating of the header data for the batch data comprises:
determining the batch object count as the number of objects in the header data;
determining the identifier as an identifier in the header data;
determining a next-batch start data tag in the header data; and
creating the header data for the batch data based on the identifier, the number of objects, the next-batch start data tag, a name of the object, and a range of data of the object in the response data.

15. The device according to claim 14, wherein the sending of the response data to the client comprises:
in response to interruption of a network connection to the client, saving the virtual object for a period of time; and
in response to receiving from the client a request to continue loading data, sending the response data to the client.

16. The device according to claim 15, wherein the request to continue loading data comprises an identifier for the virtual object and a start data tag, and the sending of the response data to the client comprises:
determining the virtual object based on the identifier for the virtual object;
determining response data for the request based on the virtual object and the start data tag; and
sending the response data to the client.

17. The device according to claim 16, wherein the determining of the response data for the request based on the virtual object and the start data tag further comprises:
reading, according to a reading manner in which a sequence number value in a data tag is not less than a sequence number value in the start data tag, batch data whose total number of objects does not exceed the batch object count from the data block based on the data index in the virtual object.

18. The device according to claim 11, wherein the request comprises a start data tag and an object filtering condition, and the determining of the metadata list of the object that meets the request further comprises:
determining, based on the start data tag, a reading manner for metadata in a metadata block;
reading, based on the reading manner, metadata of the object that meets the object filtering condition; and
determining the metadata list based on the metadata, wherein the metadata list comprises the metadata.

19. The device according to claim 18, wherein the determining of the reading manner for the metadata in the metadata block further comprises:
in response to the start data tag being specified, reading the metadata in the metadata block according to a reading manner in which a sequence number value in a data tag is not less than a sequence number value in the start data tag; or
in response to the start data tag not being specified, reading the metadata from a start position in the metadata block.

20. A computer program product, the computer program product being stored on a non-transitory computer-readable medium and comprising machine-executable instructions, wherein the machine-executable instructions, when executed, cause a machine to perform operations, comprising:
in response to receiving a request for data query from a client, determining a metadata list of an object that satisfies the request;
creating a virtual object based on the metadata list, the virtual object comprising an identifier and a data index;
determining response data for the request based on the virtual object; and
sending the response data to the client.
